(19) United States
(12) Patent Application Publication
(10) Pub. No.: US 2009/0159155 A1
(43) Pub. Date: Jun. 25, 2009

(54) Tree Stump Grinding Machine

(75) Inventor: Patrick A. Watts, Oxfordshire (GB)

Correspondence Address: COATS & BENNETT, PLLC, 1400 Crescent Green, Suite 300, Cary, NC, 27518, US

(73) Assignee: Multi-tip Designs Limited, Oxfordshire (GB)

(21) Appl. No.: 11/961,504

(22) Filed: Dec. 20, 2007

(51) Int. Cl. A01G 23/06

(52) U.S. Cl. 144/24.12; 144/235

(57) ABSTRACT

A tree stump grinding machine includes a rotor having at least one or more peripheral slots therein and defining a rotor plane. One or more teeth are removably disposed in corresponding slots and form a primary cutting face. A secondary cutting face is formed by a protrusion on the tooth and/or a keeper plate associated with the tooth. The secondary cutting face may be formed by a protrusion on the keeper plate oriented perpendicular to the plane of the rotor, and/or the secondary cutting face may be disposed circumferentially and/or radially offset with respect to the primary cutting face on either of both of the tooth and the keeper plate.

### BACKGROUND

The present invention relates to tree stump grinding machines, and in particular to the configuration of the teeth and/or the retention thereof in a grinding rotor or wheel of such a machine.

It is known in the prior art to provide a tree stump grinding machine with a cutting wheel (or “rotor”) driven by a belt, a chain, shafts, or hydraulic motors. Typically, the cutting wheel is circular with a number of receiving brackets positioned around the rim. The receiving brackets have channels into which are fitted individual cutting teeth. Each tooth is individually mounted and a gauge is often required to set each tooth at the correct distance from the center of the wheel. Each tooth is held in place by retaining bolts that are tightened to a very high degree in order to properly hold the teeth. The bolts and retaining brackets are required to take the full rotational force of the grinding action. The wheel is provided with a plurality of teeth, some of which are fitted to cut vertically while others are fitted to cut horizontally, as the wheel moves along a horizontal and vertical axis. An example of such a grinding wheel is found in U.S. Pat No. 6,484,766.

The teeth and receiving brackets described above have to be changed regularly as a result of the considerable wear that they encounter in use. Changing the teeth and receiving brackets is time consuming because of the set up accuracy required. Each tooth is generally held in place using two bolts to secure the receiving bracket and the tooth. The task of changing the teeth is invariably complicated by the earth and mud that clogs the teeth, brackets, and bolt threads which then require cleaning prior to fitting of a new tooth. Further, the receiving thread in the cutting wheel and the bolt or bolts may become cross-threaded as a result of the earth and mud, and require repair before a new tooth can be fitted. In addition to the expense incurred in a long down-time to change the teeth, the teeth and receiving brackets themselves are expensive because of the number of heavy duty components.

Currently co-pending U.S. patent application Ser. No. 10/588,348 (filed as a U.S. national phase on Aug. 3, 2006), which is incorporated herein by reference in its entirety, describes a tooth for use in a tree stump grinding wheel. In some embodiments, a keeper plate is used to retain the tooth in the grinding wheel. While the '348 application describes one or more embodiments of a keeper plate and/or tooth, there remains a need for alternative designs.

### SUMMARY

In one embodiment, the present invention provides a novel tree stump grinding machine that includes a rotor having at least one peripheral slot therein; a cutting tooth removably disposed in the slot and having a primary cutting face; a fastener operatively securing the tooth to the rotor; and a secondary cutting face disposed circumferentially offset with respect to the primary cutting face and nearer a rotational center of the rotor than the primary cutting face. In some embodiments, the tooth may comprise a cutting tip disposed radially inward from the primary cutting face and forming the secondary cutting face. In some embodiments, the device may include a keeper plate disposed circumferentially adjacent the tooth in the slot and secured to the rotor, the keeper plate comprising a cutting tip that forms the secondary cutting face.

In another embodiment, the present invention provides a tree stump grinding machine that includes a novel keeper plate configuration. The tree stump grinding machine includes a rotor having at least one peripheral slot therein and defining a rotor plane; a tooth removably disposed in the slot and having a primary cutting face; a keeper plate distinct from the tooth and disposed circumferentially adjacent the tooth in the slot; means for coupling the keeper plate to the tooth; a fastener removably securing the keeper plate to the rotor; and a secondary cutting face formed by a second protrusion on the keeper plate oriented perpendicular to the rotor plane. The secondary cutting face may be disposed circumferentially and/or radially offset with respect to the primary cutting face. For example, the second protrusion may be disposed nearer a rotational center of the rotor than the primary cutting face. In some embodiments, the slot may be enlarged toward a rotational center of the rotor to form an aperture, with an insert disposed in the aperture. The fastener may engage the insert to couple the insert and the keeper plate to the rotor. In some embodiments, the keeper plate may be formed of a softer material than the rotor.

The present invention improves the grinding efficiency by reducing the amount of time it takes to remove a tree stump.

### BRIEF DESCRIPTION OF THE DRAWINGS

FIG. 1 shows a tree stump grinding machine incorporating a grinding wheel and a plurality of teeth.

FIG. 2A shows a cross-section of a rotor with the teeth removed for clarity.

FIG. 2B shows the grinding wheel fitted with a number of teeth.

FIGS. 3A-3B show perspective views of a single tooth.

FIGS. 4-5 show a grinding wheel that utilized keeper plates.

FIG. 6 shows a keeper plate according to one embodiment of the present invention.

FIG. 7 shows a keeper plate and an insert for retaining the keeper plate.

FIG. 8 shows another embodiment of a keeper plate and tooth.

FIG. 9 shows another embodiment of a tooth that includes at least one protrusion forming a secondary cutting face.

### DETAILED DESCRIPTION

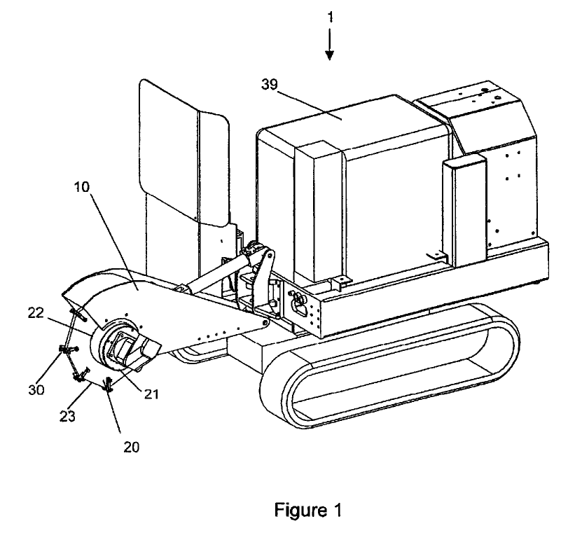

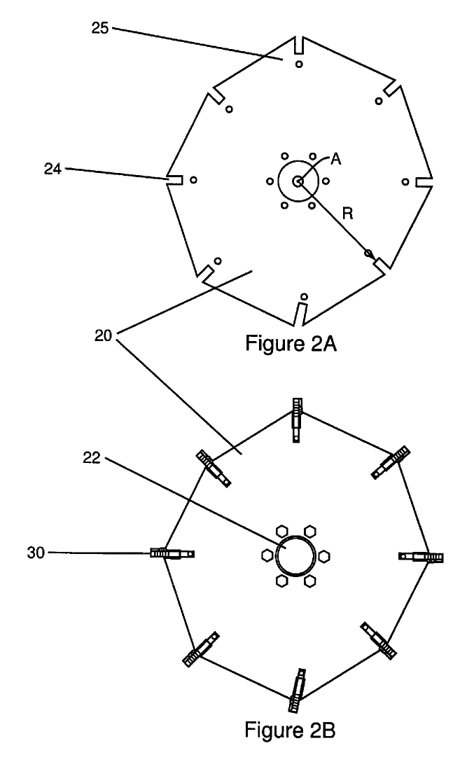

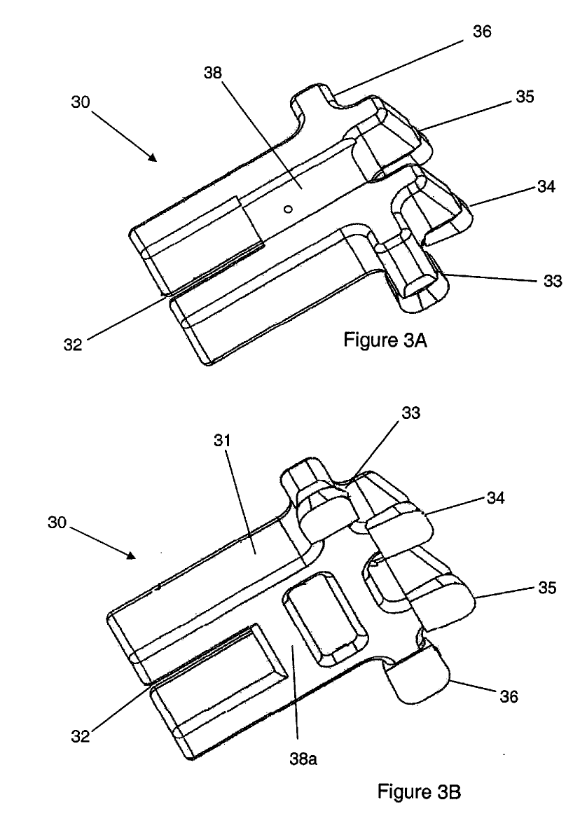

FIG. 1 shows a known grinding machine 1 that includes a support arm 10, a rotor (grinding wheel) 20, and a plurality of teeth 30. The arm 10 forms a housing for a transmission which may be a belt, chain drive shaft, hydraulic motor, or the like. The rotor 20 is caused to rotate by a driving engine 39 that transmits the power via the transmission housed in the support arm 10. The rotor 20 is attached a central hub 22 which passes through a set of bearings contained within a bearing housing 21 which is attached to the arm 10. As shown in FIGS. 2A-2B, a plurality of slots 24 located on the corners of the rim 23 of rotor 20. These slots 24 are advantageously generally radially oriented, but may, if desired, be oriented at an angle relative to a radial direction. The slots 24 are used to accommodate the teeth 30. In the illustrated embodiment, the rotor 20 is octagonal, although almost any polygonal shape may be used, in particular a hexagon or decahedron.

FIG. 2A shows a cross section of the rotor 20 and FIG. 2B shows the rotor 20 fitted with teeth 30. For the illustrated embodiment, eight teeth 30 are provided, one at each corner of the rotor 20. The irregular shape of the rotor 20 results in the radius R from the rotor's axis of rotation A to the teeth 30 and/or slots 24 varying along the rotor's circumference. As such, the teeth 30 are not equidistant from the hub 22 of the rotor 20. For some embodiments, the teeth 30 are arranged in two series, each covering 180° of the rotor 20. Within a given series of teeth 30, the distance of each tooth 30 from the rotor's axis of rotation A is greater than the adjacent tooth in the direction that the rotor 20 rotates. Thus, the teeth 30 of the resulting rotor 20 grind a little more of the tree stump as each tooth 30 comes to make contact with the tree stump.

FIGS. 3A-3B show a tooth 30 that has a body 31, a slot 32, and a plurality of cutting tips 33, 34, 35, and 36. The slots 24 on the rotor 20 interface with the slots 32 on the teeth 30 through the abutment of back and front planar surfaces 38, 38a of the tooth 30 with adjacent planar surfaces that form the slot 24 of the rotor 20. The four cutting tips 33-36 are arranged in two orthogonal pairs allowing efficient cutting in radial and lateral directions simultaneously. The body 31 may include a shallow channel in the back face that forms planar surface 38 that allows the rotor 20 to take up forces from the tooth 30 in the lateral plane.

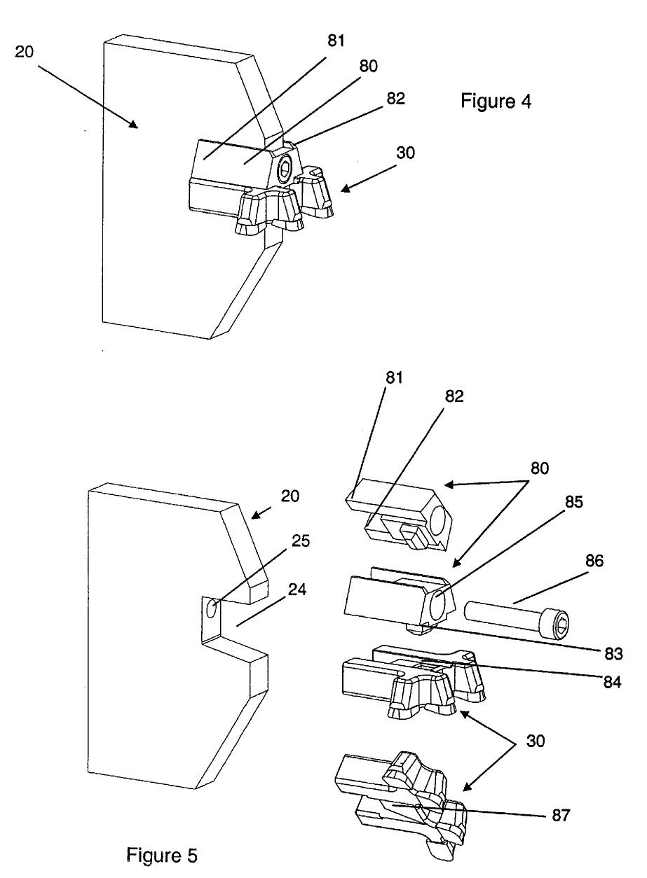

FIGS. 4-5 show a rotor 20 including a keeper plate 80 as described in U.S. patent application Ser. No. 10/588,348, discussed above. The keeper plate 80 is shown in FIG. 4 in a position between the tooth 30 and the rotor 20. The keeper plate 80 is a generally U-shaped member that abuts the tooth 30 and enables the tooth 30 to be tightened relative to the rotor 20. The keeper plate 80 has two leg portions 81, 82 at an inner end which abut the sides of rotor 20. The leg portions 81,82 extend transversely beyond the edge of rotor slot 24, which prevents any movement in a direction perpendicular to the plane of rotor 20. The keeper plate 80 is also provided with a lug 83 which interfaces with a notch 84 in the upper surface of the tooth 30. As can be appreciated, the relationship of the lug 83 and the notch 84 may be reversed, if desired, so that the lug 83 is associated with the tooth and the notch associated with the keeper plate 80. The keeper plate 80 is also provided with a bore 85 and counter bore (not shown) arrangement that enables a bolt 86 to be screwed through bore 85 from the forward end of keeper plate 80 and into the hole 25 provided in the rotor 20. In alternate embodiments, the bolt 86 may instead extend through a bore in the tooth 30, rather than through keeper plate 80.

As can be seen, tooth 30 may be provided with a tapered surface 87. The taper is advantageously radial and provides a broader tooth cross-section closer to the tip of the tooth 30 and a narrower tooth cross-section closer to the center of the rotor 20 when the tooth 30 is positioned for use on the rotor 20. Just by way of example, the taper may be at approximately 11°. The slot 24 in the rotor 20 may also be provided with a corresponding taper.

When the tooth 30 is initially fitted into the rotor 20, bolt 86 is screwed into the keeper plate 80 so that the tooth 30 is held securely. After the tooth 30 has been used for some time, the tooth 30 may work loose and begin to move slightly relative to the rotor 20. When this occurs, bolt 86 may be tightened so that keeper plate 80 and tooth 30 move together radially inwardly toward the center of rotor 20. As a result of the tapered surface 87 on the lower part of the tooth 30 and matching taper on the slot 24, the tooth 30 will be tightened into position on the rotor 20 by the action of the bolt 86 being tightened.

FIG. 5 shows the tooth 30 being replaced. It is not necessary to remove the bolt 86 entirely from the keeper plate 80 and therefore keeper plate 80 may remain attached to the rotor 20 throughout the tooth replacement procedure. This is possible because, once the bolt 86 has been loosened, there will be sufficient movement possible between rotor 20 and keeper plate 80 to allow the tooth 30 to fall out of position and to be replaced by a new tooth 30.

The keeper plate 80 and the tooth 30 may be made from a metal that is soft in comparison with the metal of rotor 20 so that keeper plate 80 will wear more quickly than rotor 20 and can be replaced more conveniently. The use of a keeper plate 80 therefore increases the useful life of rotor 20. In this example, the rotor 20 is manufactured from hardened steel, such as HARDOX 400, while the keeper plate 80 may be manufactured from drop forged steel, or the like.

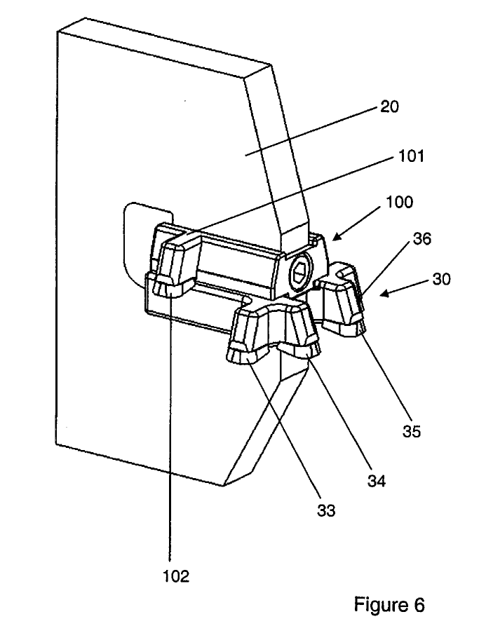

FIG. 6 shows a keeper plate 100 in accordance with the present invention. The keeper plate 100 may share any or all of the attributes of keeper plate 80 discussed above, which are not repeated herein for brevity. In addition, keeper plate 100 includes a projection 101 having a cutting tip 102 which projects out of the plane of rotor 20. This cutting tip 102 forms a secondary cutting face, as contrasted with the primary cutting face formed by cutting tips 33-36. While not shown in FIG. 6, a complementary cutting tip 102 may also be provided on the opposite side of the keeper plate 100, if desired. The cutting tip 102 in this example is disposed at a position on the keeper plate 100 which is radially inwardly of the cutting tips 33-36 on tooth 30. That is, the cutting tip 102 is disposed toward the inner end of the keeper plate 100. However, in some embodiments, cutting tips 102 may alternatively and/or additionally be disposed toward the forward end of keeper plate 100. The cutting tips 102 are also advantageously located in a position that circumferentially offset from the primary cutting face formed by cutting tips 33-36.

The cutting tip 102 allows the grinding machine 100 to cut deeper into a tree stump in comparison with a conventional grinding machine. The support arm 10 of the grinding machine 1 is swept back and forth such that the rotor 20 is swept back and forth across the tree stump, with each sweep allowing a slightly deeper cut into the tree stump. The cutting tip 102 acts to increase the depth of the cut into the tree stump because it provides an additional cutting face.

The cutting tip 102 is located circumferentially away from the tooth cutting tips 33-36 so that the impact of each of the cutting tips 102 and 33-36 on the tree stump are staggered. In other words, during operation of the grinding machine 1, the cutting tip 102 will hit the tree stump after the cutting tips 33-36 have hit the tree stump. During operation of the grinding machine 100, the rotor 20 is required to rotate at a high speed, and the staggering of each impact of the cutting tips allows the rotor to maintain the torque needed to keep rotating.

By locating cutting tip 102 on keeper plate 100, the load that acts on the cutting tips 102, 33-36 is dispersed. If the cutting tip 102 was to be provided at a similar radial location, but on tooth 30, the pressure acting on the various cutting tips of tooth 30 would be much greater than when the cutting tip 102 is disposed on the keeper plate 100. This increased loading may lead to damage of the tooth 30 when the tooth 30 impacts the tree stump.

It is preferable to position the cutting tip 102 closer to the center of the rotor 20 than the cutting tips 33-36 because this results in less wear on the cutting tip 102. There is less wear on the cutting tip 102 because of the distance that the cutting tip 102 is located from the outer edge of the rotor 20. When the rotor 20 rotates, the outer edge will run in detritus, such as soil, stones and the wood removed from the tree stump. The inwardly positioned cutting tip 102 will be subjected to less detritus than the cutting tips 33 to 36. Furthermore, the operator of the grinding machine 1 will not always make a deep enough cut in the tree stump to engage the cutting tip 102.

The provision of the cutting tip 102 is advantageous because if it allows the grinding machine 1 to cut deeper in a tree stump for a given amount of power. The provision of the cutting tip 102 on the keeper plate 100 is also advantageous for economic reasons. This is because when the cuttings tips 33-36 on the tooth 30 are worn, so that the tooth 30 needs to be replaced, it is not always necessary to replace the cutting tip 102 provided on the keeper plate 100 since the cutting tips 33-36 wear at a faster rate than the cutting tip 102.

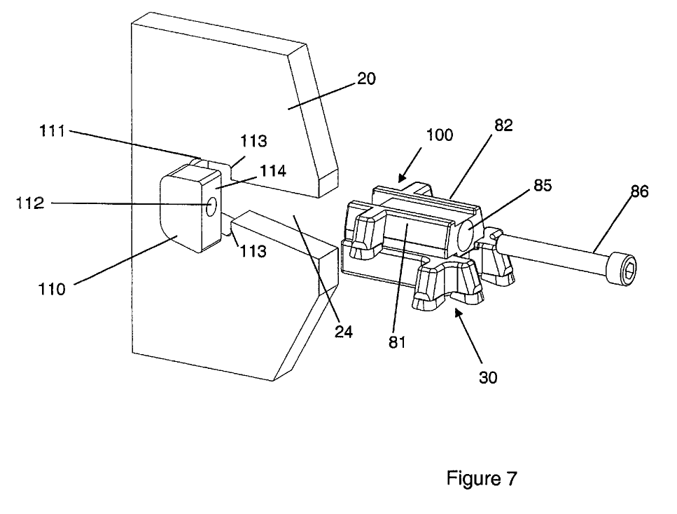

FIG. 7 shows an exploded view of the rotor 20, the tooth 30, the keeper plate 100 and an insert 110. The slot 24 is enlarged at its radially inward end to form an aperture 111 which is sized such that it receives the insert 110. The insert 111 is provided with a threaded bore 112 into which the bolt 86 is screwed in order to retain the keeper plate and the tooth 30. The insert 110 and the aperture 111 are shaped as shown in FIG. 7 such that they retain the keeper plate 100 in a radial direction as surfaces 113 and 114 abut against each other. The tooth 30, the keeper plate 100 and the insert 110 are retained in a direction perpendicular to plane of the rotor 20 by the legs 81 and 82 as described above in relation to FIGS. 4-5. The insert 110 is removable from the rotor 20 so that if the thread in the bore 112 is damaged, it is not necessary to replace the rotor 20 or re-tap a bore in the rotor 20, if the bore 112 was provided in the rotor.

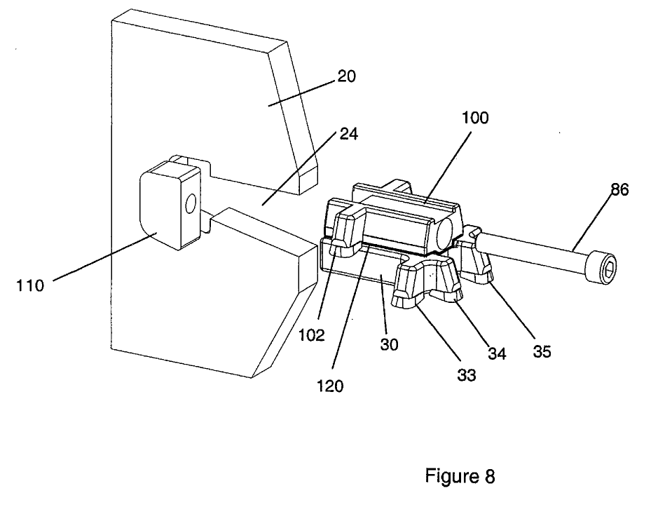

While it is believed advantageous if the keeper plate 100 and tooth 30 are readily separable when removed from rotor 20, the keeper plate 100 may be relatively permanently attached to the tooth 30 in some embodiments. For example, the keeper plate 100 of FIG. 8 is attached to tooth 30 by a suitable strong adhesive 120 formed as a layer between the underside of keeper plate 100 and the top side of tooth 30. Alternatively, the keeper plate 100 may be secured to the tooth 30 by welding, brazing, or like, or by a fastener (not shown) that extends generally perpendicularly to bolt 86 (e.g., circumferentially with respect to rotor 20), or by other securing means known in the art.

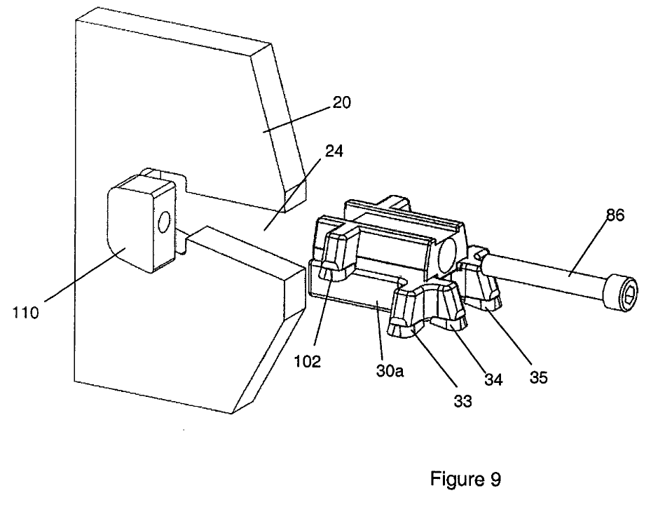

In another embodiment, the tooth 30 itself is modified to provide the secondary cutting face at a location that is both circumferentially and radially offset from the primary cutting face. For example, FIG. 9 shows a tooth 30a that includes a cutting tip 102 that is both circumferentially and radially offset from the primary cutting face formed by cutting tips 33-36.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein

What is claimed is:

1. A tree stump grinding machine, comprising:
a rotor having at least one peripheral slot therein and defining a rotor plane;
a tooth removably disposed in said slot and having a primary cutting face;
a keeper plate distinct from said tooth and disposed circumferentially adjacent said tooth in said slot;
means for coupling said keeper plate to said tooth;
a fastener removably coupling the keeper plate to the rotor; and
a secondary cutting face formed by a second protrusion on said keeper plate oriented perpendicular to the rotor plane.

2. A tree stump grinding machine according to claim 1 wherein the secondary cutting face is disposed circumferentially offset with respect to the primary cutting face.

3. A tree stump grinding machine according to claim 1 wherein the secondary cutting face is disposed nearer a rotational center of the rotor than said primary cutting face.

4. A tree stump grinding machine according to claim 4 wherein the second protrusion is disposed proximate an inner end of the keeper plate with respect to the rotational center of the rotor.

5. A tree stump grinding machine according to claim 1 wherein the slot is enlarged toward a rotational center of the rotor to form an aperture, and further comprising an insert disposed in said aperture; wherein said fastener engages said insert.

6. The tree stump grinding machine of claim 1 wherein said tooth comprises a plurality of cutting tips.

7. The tree stump grinding machine of claim 6 wherein at least one of said cutting tips is disposed generally perpendicular to another of said cutting tips.

8. The tree stump grinding machine of claim 1 wherein said keeper plate is formed of a softer material than said rotor.

9. The tree stump grinding machine of claim 1 wherein said rotor comprises a plurality of slots, and further comprising a plurality of teeth disposed in corresponding slots.

10. The tree stump grinding machine of claim 1 wherein said fastener comprises a bolt.

11. The tree stump grinding machine of claim 1 wherein said tooth comprises said recess.

12. The tree stump grinding machine of claim 1 wherein said coupling means comprises a first of a protrusion and a recess associated with said keeper plate and the other of said protrusion and said recess associated with said tooth; said protrusion and said recess engaging one another to couple said tooth to said keeper plate.

13. The tree stump grinding machine of claim 1 wherein said fastener extends through a corresponding bore in said keeper plate.

14. The tree stump grinding machine of claim 1 wherein said keeper plate is bonded to said tooth.

15. A tree stump grinding machine, comprising:
a rotor having at least one peripheral slot therein;
a cutting tooth removably disposed in said slot and having a primary cutting face;
a fastener operatively securing the tooth to the rotor; and
a secondary cutting face disposed circumferentially offset with respect to the primary cutting face and nearer a rotational center of the rotor than said primary cutting face.

16. A tree stump grinding machine according to claim 15 further comprising a keeper plate disposed circumferentially adjacent said tooth in said slot and secured to said rotor, said keeper plate comprising a cutting tip is disposed proximate an inner end of the keeper plate with respect to the rotational center of the rotor and forming said secondary cutting face.

17. The tree stump grinding machine of claim 16 wherein the fastener extends through a bore in said keeper plate.

18. The tree stump grinding machine of claim 15 wherein said rotor comprises a plurality of slots, and further comprising a plurality of cutting teeth disposed in corresponding slots.

19. The tree stump grinding machine of claim 15 wherein said cutting tooth comprises a cutting tip disposed radially inward from said primary cutting face and forming said secondary cutting face.

20. The tree stump grinding machine of claim 15 wherein said slot is oriented radially with respect to a rotational center of said rotor.
